(19) United States
(12) Patent Application Publication
(10) Pub. No.: US 2011/0142377 A1
(43) Pub. Date: Jun. 16, 2011

(54) Laminate Bag Having Windows

(75) Inventor: David Bradley, Hagerstown, MD (US)

(73) Assignee: AMCOR FLEXIBLES, INC.

(21) Appl. No.: 12/638,011

(22) Filed: Dec. 15, 2009

(51) Int. Cl. B65D 33/04; B31F 7/00; B32B 29/00

(52) U.S. Cl. 383/106; 156/265; 428/537.5

(57) ABSTRACT

The present invention provides a bag having front and back panels that are arranged in opposing face-to-face relation with each other and are interconnected to define an interior space of the bag. The front and back panel each include a window portion and an opaque portion. The window portion comprises a transparent sheet material through which the interior space and contents of the bag can be seen. The front and back panels are configured and arranged with respect to each other such that the opaque portion of the back panel is aligned opposite the window portion of the front panel, and the window portion of the back panel is aligned opposite the opaque portion of the front panel. As a result, when one looks through the window portion of either the front or back panels, the opaque portion of the opposite panel is seen.

### CROSS REFERENCE TO RELATED APPLICATIONS

This application is related to commonly owned copending Provisional Application Ser. No. 60/138,281, filed Dec. 17, 2008, incorporated herein by reference in its entirety, and claims the benefit of its earlier filing date under 35 U.S.C. 119(e).

### FIELD OF THE INVENTION

The present invention relates generally to food bags, and more particularly to food bags having an outer opaque layer and a transparent film inner layer.

### BACKGROUND OF THE INVENTION

In the retail consumer food industry, it is very important to package food items in a package that provides protection from the surrounding environment. To meet these demands, various bags have been developed that are formed from polymeric films and can be used for packaging a wide variety of food items. Films suitable for each of these applications are typically required to exhibit a range of physical properties. Food packaging films in particular may be required to meet numerous demanding performance criteria, depending on the specific application. Exemplary performance criteria may include outstanding dimensional stability, i.e. a high modulus at both room and elevated temperatures, impact resistance, and good transparency.

Horizontal and vertical form-fill-seal processes (HFFS and VFFS, respectively) are particularly rigorous food packaging applications. HFFS is commonly used to form flexible packaging for hot dogs, lunch meats and the like. In HFFS packaging, foodstuffs are introduced into multiple container-like pockets that have been formed across the width of a continuous roll of film (“the forming film”). The pockets are initially thermoformed and then filled as the forming film is continuously transported down a single production line. A second film (“the non-forming film”) is unwound and superposed over the forming film after it has been filled. The two films are then heat sealed at the flat surfaces surrounding the perimeter of each of the forming film pockets. The sealed pockets are then severed at the bonded flat surface, thus forming a final product suitable for sale.

In VFFS packaging, foodstuffs are introduced through a central, vertical fill tube and into a formed tubular film that has been heat-sealed transversely at its lower end. After being filled, the package, in the form of a pouch, is completed by transversely heat-sealing the upper end of the tubular segment, and severing the pouch from the tubular film above it, usually by applying sufficient heat to melt through the tube above the newly formed upper heat-seal, or by severing the sealed packages from each other at the bonded surfaces. If the films used in HFFS and VFFS packages do not have sufficient dimensional stability or modulus, the package may tend to stretch and become distorted during the severing process.

One such package that has been developed is a paper/plastic laminate in which a sheet of paper is laminated to a polymer film layer. The paper generally provides an outer surface that is printable while the film layer provides barrier protection. However, in addition to having the desirable physical properties, it may also be important for the package to have an aesthetically pleasing appearance that will appeal to the consumer. In particular, it may be desirable to provide a package that allows the consumer to view the contents of the package prior to making a purchase. Accordingly, there still exists a need for a package that can be used in packaging applications that require sufficient dimensional stability, and that provides an aesthetically appealing package.

### BRIEF SUMMARY OF THE INVENTION

In one embodiment, the present invention provides a bag having front and back panels that are arranged in opposing face-to-face relation with each other and are interconnected to define an interior space of the bag. The front and back panel each include a window portion and an opaque portion. The window portion comprises a transparent sheet material through which the interior space and contents of the bag can be seen. The front and back panels are configured and arranged with respect to each other such that the opaque portion of the back panel is aligned opposite the window portion of the front panel, and the window portion of the back panel is aligned opposite the opaque portion of the front panel. As a result, when one looks through the window portion of either the front or back panels, the opaque portion of the opposite panel is seen.

The bag is preferably constructed of a laminate comprising a transparent inner layer of a polymeric sheet material to which a substantially opaque outer layer of paper is fixedly joined. The outer paper layer is selectively joined to the inner layer to thereby define the opaque portion of each panel and the window portion of each panel. The window portion of each panel is thus defined by region of the inner layer that is not covered by the outer layer.

Suitable polymeric sheet materials for use in the present invention may include polyethylene, polypropylene, polyester, and nylon. In a preferred embodiment, the inner layer comprises a polymeric material that is uniaxially oriented or biaxially oriented. In some embodiments, the polymeric sheet material of the inner layer may be subjected to a corona discharge ionizing treatment so as to render the outer surfaces of each panel receptive to adhesives, as well as to standard printing inks. Preferably, the outer layer comprises kraft paper.

The combination of the opaque portions and window portions of the bag provide a bag having an aesthetically appealing appearance without sacrificing functionality. In particular, the window portion provides a means through which consumers can view the interior contents of the bag.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a front perspective view of a bag that is in accordance with the present invention;

FIG. 2 is a front view of the bag of FIG. 1;

FIG. 3 is a back view of the bag of FIG. 1;

FIG. 4 is a cross-sectional view of a bag that is in accordance with the present invention taken along line 4-4 of FIG. 2;

FIG. 5 is a schematic illustration of a method of preparing a laminate that is in accordance with the claimed invention; and

FIG. 6 illustrates a vertical form fill and seal apparatus that may be used in producing packaged products utilizing the bag of the invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

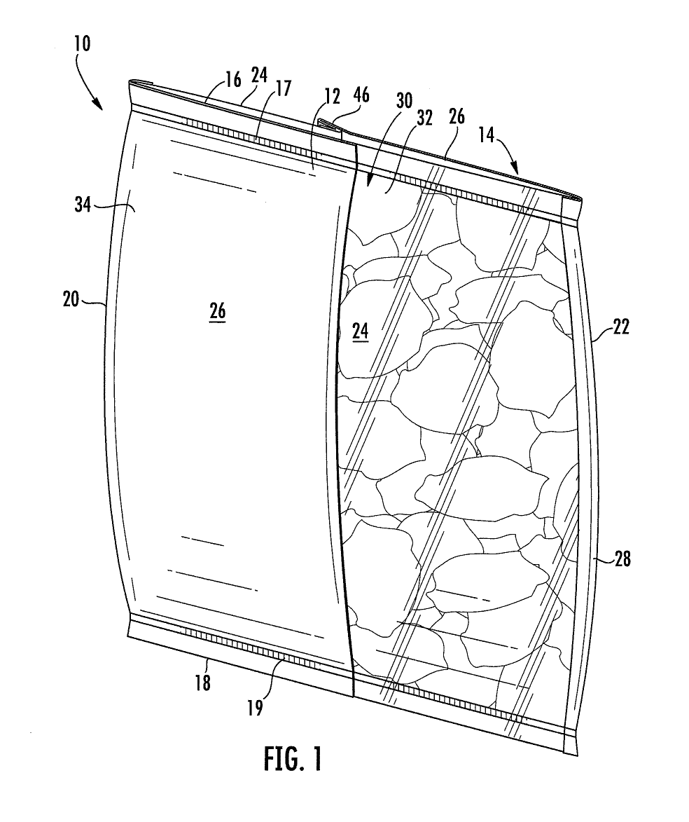

With reference to FIG. 1, a bag that is in accordance with one embodiment of the present invention is illustrated and broadly designated by reference character 10. The bag 10 comprises front and back panels 12, 14 that are arranged in opposing face-to-face relation with each other and are interconnected to define an interior space of the bag. The bag includes a top end 16, a bottom end 18, and a pair of opposing side edges 20, 22 that extend longitudinally between the top and bottom ends of the bag. In the illustrated embodiment, the top end of the bag is sealed with top seam 17 and the bottom end of the bag is sealed with bottom seam 19. In the context of the invention, the term “bag” is used in a generic sense and should be recognized to include, sacks, pouches, satchels and the like.

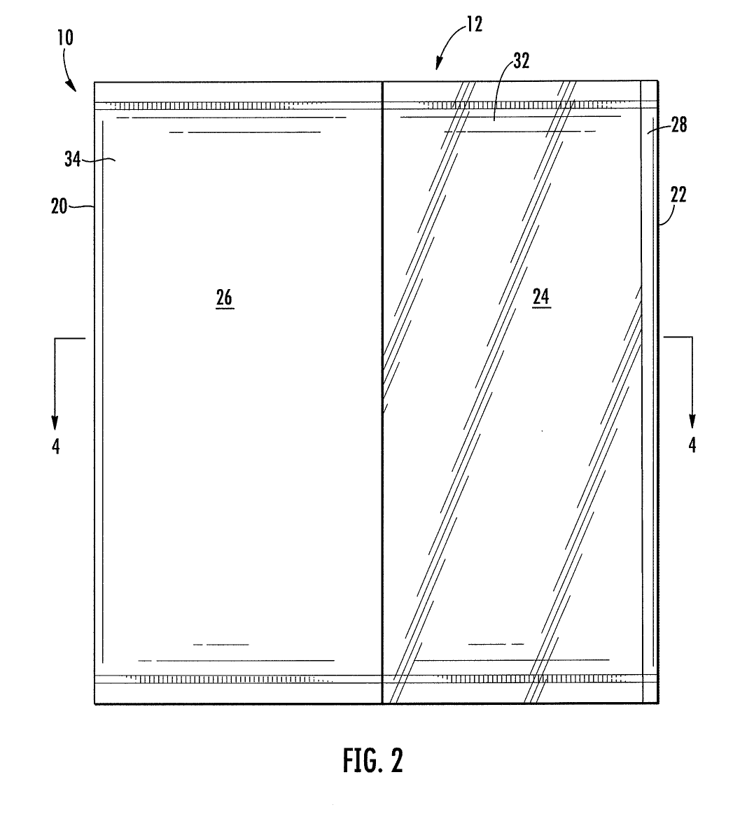

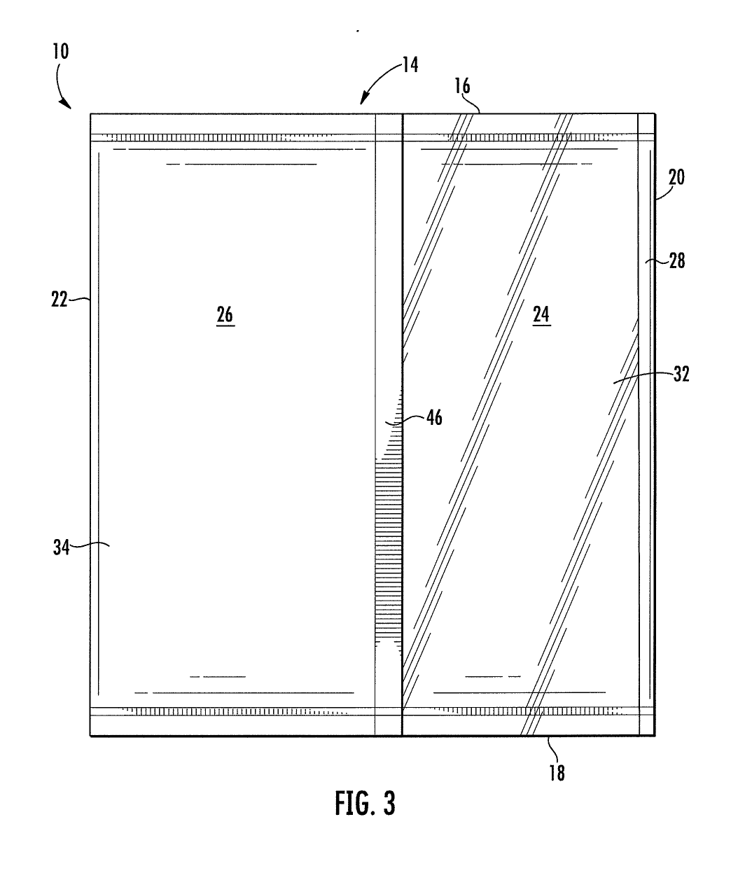

The front and back panel each include a window portion 24 and an opaque portion 26. The window portion comprises a transparent sheet material through which the interior space of the bag and its contents can be seen. For example, in the illustrated embodiment, a food product is disposed in the interior space of the bag and can be seen through window portion 24. FIG. 2 is an illustration of the front panel 12 of the bag, and FIG. 3 is an illustration of the back panel 14 of the bag. As can best be seen in FIGS. 2 and 3, the front and back panels are configured and arranged with respect to each other such that the opaque portion 26 of the back panel is aligned opposite the window portion 24 of the front panel, and the window portion 24 of the back panel is aligned opposite the opaque portion 26 of the front panel. As a result, when one looks through the window portion of either the front or back panels, the opaque portion of the opposite panel is seen. In the illustrated embodiment, the window portion and opaque portion of each panel extends longitudinally from the top end 16 to the bottom end 18 of the bag. In other embodiments, the window portion and opaque portion can be arranged in other configurations. For example, in one embodiment the window and opaque portions extend laterally across the width of the bag between the opposing side edges, or can extend diagonally between opposing diagonal corners of the bag.

The front and back panels each comprise a laminate having a transparent inner layer 32 comprising a polymeric sheet material to which a substantially opaque outer layer 34 is fixedly joined to at least a portion thereof. As can be seen in FIGS. 2 and 3, the outer layer 34 is selectively joined to the inner layer 32 to thereby define the opaque portion of each panel and the window portion of each panel. The window portion of each panel is thus defined by region of the inner layer that is not covered by the outer layer 34.

Preferably, the inner layer of the front and back panels comprises a polymeric sheet material having an interior surface comprising a heat sealable material. In the particular embodiment illustrated, the front and back panels are made from a heat sealable material and the top and bottom ends of the bag are sealed by producing a fusion bond or seal between contacting interior surfaces of the front and back panels using pressure and heat or ultrasonic energy as is well known. Although referred to herein as “heat seals”, it should be understood that this term is intended to apply both to seals formed by heating the contacting surfaces with a heated anvil or platen, as well as to heating and fusion produced by other methods, such as application of ultrasonic energy. Suitable polymeric sheet materials for use in the present invention may include polyethylene, polypropylene, polyester, and nylon.

In a preferred embodiment, the inner layer comprises a polymeric material that is uniaxially oriented or biaxially oriented. For example, the inner layer can be biaxially oriented in both the longitudinal and transverse directions. Typically, the inner layer has a thickness ranging from about 0.5 to 5 mils, and more typically, from about 1 to 2 mils. In a preferred embodiment, the thickness of the inner layer is no more than about 2 mils.

In some embodiments, it may be desirable to treat the outer surface of the inner layer to a corona discharge ionizing treatment so as to render the outer surfaces of each panel receptive to adhesives, as well as to standard printing inks. It is noted that many polymeric materials, such as polypropylene are not receptive to adhesives or inks. Treating the outer surface of the inner layer to a corona discharge treatment helps to make the outer surfaces of the polymeric sheet material wettable, and as a result, receptive to adhesives and inks.

As noted above, the outer layer 34 of the bag comprises a material that is substantially opaque. Preferably, the outer layer 34 comprises a cellulose material, such as kraft paper. In one embodiment, the outer layer comprises kraft paper having a basis weight between 15 to 40 g/m², and in particular, between about 5 to 20 g/m². Other materials that may be used for the opaque outer layer may include foils, vegetable parchment, as well as other types of papers.

Preferably, the opaque portion of each panel comprises between about 40 to 60 percent of surface area of each panel, and similarly, the window portion of each panel comprises between about 40 to 60 percent of surface area of each panel. In one particular embodiment, window and opaque portions of each panel comprises between about 45 to 55 percent of surface area of each panel. In the illustrated embodiment, the opaque portion of each panel extends from an adjacent side edge of the bag 20, 22 towards a middle region 30 of each panel so that about one half (e.g., about 50%) of each panel comprises the opaque portion and the other half (e.g., about 50%) of the panel comprises the window portion. In the illustrated embodiment, the window and opaque portions have a generally rectangular shape.

In one embodiment, the front and back panels are substantially unconnected to each other along the top end of the bag to define an opening through which items can be introduced into the interior space of the bag. After the bag has been filled, the open top end of the bag can be closed, preferably with a heat seal.

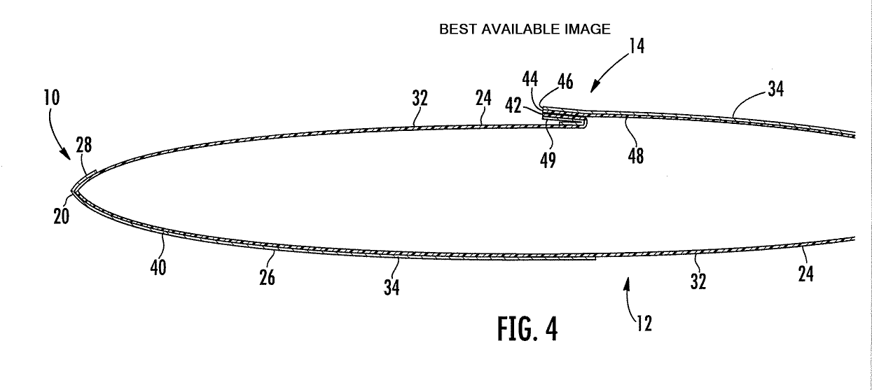

Turning to FIG. 4, a cross-sectional view of the bag 10 taken along line 4-4 of FIG. 2 is illustrated. In this embodiment, the bag 10 is formed from a laminate 40 having transparent inner layer 32 and opaque outer layer 34. As shown, the bag 10 has a generally tube-like structure in which the front and back panels are formed from a single sheet of laminate 40. In this embodiment, laminate 40 includes longitudinal side edges 42, 44 extending along the length of the laminate that are sealed to each other along vertical seam 46. The tube-like structure of bag 10 is created by folding the laminate along its length so that the two opposing longitudinal edges may be adhered to each other to form a vertical seal along the length of the bag. For example, laminate 40 is folded in such a manner that the inner surface 48 of the inner layer adjacent to the longitudinal side edges 42, 44 is superimposed and heat sealed to itself to form vertical seam 46. This type of seam is commonly referred to as a fin seal. It should be recognized that other seals may be used in the practice of the invention including lap seals, reverse fin seals, and the like. Vertical seam 46 extends longitudinally along the length of the bag from the top end to bottom end of the bag. Folding of the laminate so that the longitudinal side edges 42, 44 of the laminate can be sealed to each other also creates the opposite side edges 20, 22 of the bag, which in turn define the front and back panels.

In the embodiment illustrated in FIG. 4, the laminate includes an additional strip of opaque material 49 that is attached to the inner layer 32 adjacent to the longitudinal side edge 42 of the laminate. Preferably, opaque material 49 comprises a strip of paper that extends longitudinally along the length of the laminate, and hence, also along the length of vertical seam 46. When present, opaque material 49 typically has a width that is between about 0.5 to 2 centimeters, and more typically between about 0.75 to 1.5 centimeters.

In some embodiment, the folds forming the opposite side edges 20, 22 of the bag are positioned so that an opaque portion of each panel wraps about an adjacent side edge of the bag and is at least partially disposed on the opposite panel. In this regard, the front and back panels of the embodiment of the bag illustrated in FIGS. 1-4 includes opaque portion 26 as well as a second opaque portion 28 that is formed by a portion of the opaque portion on the opposite panel that wraps about the side edge of the bag. As a result, the window portion 24 of each panel is disposed between opaque portion 26 and opaque portion 28. When present, the second opaque portion of each panel is preferably relatively narrow in comparison to the window portion 24 and opaque portion 26. Preferably the second opaque portion 28 is between about 0.2 to 1 centimeter wide, and more preferably has a width that is less than 0.5 centimeters. In particular, the second opaque portion 28 is desirably between 5 and 15% of the surface area of opaque portion 26.

In some applications, it may be desirable for polymeric sheet material of the inner layer, and hence the bag, to permit the passage of oxygen therethrough. In one embodiment, the inner layer has a sufficiently high oxygen transmission rate so that a desired level of oxygen may travel through the bag 10. For instance, in the packaging of produce, it may be desirable for the bag to have an oxygen transmission rate (OTR) of at least 75 cc (STP)/m²/day/atm or greater at 23° C. and 0% relative humidity, as measured according to ASTM D-3985. Unless otherwise indicated, all references to OTR in this application have been determined according to ASTM D-3985 at 23° C. and 0% relative humidity. In one embodiment, the bag has an OTR that is between about 75 and 1,000 cc (STP)/m²/day/atm, and preferably between about 75 and 240 cc (STP)/m²/day/atm. In a particularly preferred embodiment, the bag has an OTR between about 75 and 150 cc (STP)/m²/day/atm.

To achieve the desired OTR of the bag, the polymeric material of the inner layer can be selected to have a sufficiently high permeability. In one embodiment, the inner layer has a density of less that about 0.93 g/cc. It has been observed that the oxygen transmission rates of some polymers, such as polyethylenes, may generally be related to the density of the polymer. In general, the lower the density of polyethylene, the higher the OTR of the resulting film. In one embodiment, the inner layer comprises a polymeric sheet material of polyethylene having a density between about 0.86 to 0.93 g/cc.

The inner layer may include one or more thermoplastic polymers including polyolefins, polyesters, polyvinyl chlorides, and ionomers having a desired permeability to oxygen. Useful polyolefins include homogeneous polymers that are typically prepared using metallocene or other single site-type catalysts. Examples of homogeneous polymers include the metallocene-catalyzed linear homogeneous ethylene/alpha-olefin copolymer resins available from the Exxon Chemical Company (Baytown, Tex.) under the EXACT™, linear homogeneous ethylene/alpha-olefin copolymer resins available from the Mitsui Petrochemical Corporation under the TAFMER™, and long-chain branched, metallocene-catalyzed homogeneous ethylene/alpha-olefin copolymer resins available from the Dow Chemical Company under the AFFINITY™.

A desired OTR can also be achieved by perforating the inner layer of the bag. Such perforations can be done independently of the material of the inner layer or in combination with an inner layer comprising a material having some degree of permeability to oxygen. For example, a desired amount of breathibility can be obtained by providing the bag with perforations through which oxygen can be transmitted. When present, the perforations are preferably distributed over at least a portion the window portion of the bag. Preferably, the perforations have an average size ranging from about 5 to 120 microns in size and are distributed over about 5 to 75% of the surface area of the window portions of each panel. In one embodiment, the perforations are distributed over about 10 to 50% of the surface area of the window portions of each panel. The perforations can be formed in the window portion prior to formation of laminate, during the lamination process, or after the bag has been formed. In a preferred embodiment, the perforations are formed in an in-line during the process of forming the laminate. For example, the perforations can be created in the inner layer before or after the outer layer of paper has been laminated thereto.

To produce the perforations in a film web or in the bag, any conventional known perforating process or means can be used, including, for example, laser perforation, puncturing means, microperforating means, air pressure means, and the like.

In one embodiment, the perforations comprise a plurality of micro-fractures formed in the window portion of the bag. The micro-fractures generally exhibit a tear-like or slit structure and are characterized by the absence of a uniform shape or size. For example, the micro-fractures typically do not have a round or circular shape and therefore do not have what can be characterized as a diameter. In particular, the micro-fractures generally have a length that is between about 3 and 15 times the width of the fracture. In one embodiment, the micro-fractures have lengths ranging from about 10 to 140 microns and widths ranging from about 2 to 30 microns.

It has been found that in the packaging of certain products, such as produce, it may be desirable to provide the outer surface of the opaque layer with moisture resistant properties. For example, in the packaging of fresh produce, the environment in the packaging facility can be relatively humid. In such an environment, moisture in the interior of the bag may have a tendency to move or “wick” from the interior of the bag and be absorbed by the outer paper layer (e.g., the opaque portion) of the bag. Absorption of moisture into the paper can result in the bag having an unsightly appearance due to discoloration or staining of the bag.

In one embodiment, moisture resistance can be provided by coating the outer surface of the paper with an overprint varnish that helps prevent moisture from being absorbed into the paper. Overprint varnishes can be applied using conventional printing techniques. In one particular embodiment, moisture resistant papers that may be used in the present invention have a tensile strength in the machine direction that is between about 4 and 12 lbs./in², and in particular about 7.5 lbs./in² as measured in accordance with TAPPI T 494. In a preferred embodiment, the paper has a wet tensile strength in the machine direction that is between about 0.5 and 3 lbs./in², and in particular between about 1.5 and 2 lbs./in² as measured in accordance with TAPPI T 494. The paper also preferably has a tear strength in the machine direction that is between about 15 and 30 grams force, and in particular between about 20 and 25 grams force as measured in accordance with TAPPI T 460, and a tear strength in the cross direction that is between about 15 and 35 grams force, and in particular between about 25 and 30 grams force as measured in accordance with TAPPI T 460.

Laminate 40 can be formed by providing a continuous sheet of polymeric sheet material to which two continuous strips of paper are adhesively laminated in the machine direction of the polymeric sheet material (i.e., laminated longitudinally along the length of the polymeric sheet material). Preferably, the paper layer is joined to the polymeric sheet material using a cold lamination process. The use of cold lamination is particularly advantageous when an oriented or biaxially-oriented plastic film is utilized. Prior to lamination, the polymeric sheet material can be subjected to a corona discharge treatment in order to make the surface of the polymeric sheet material receptive to adhesives.

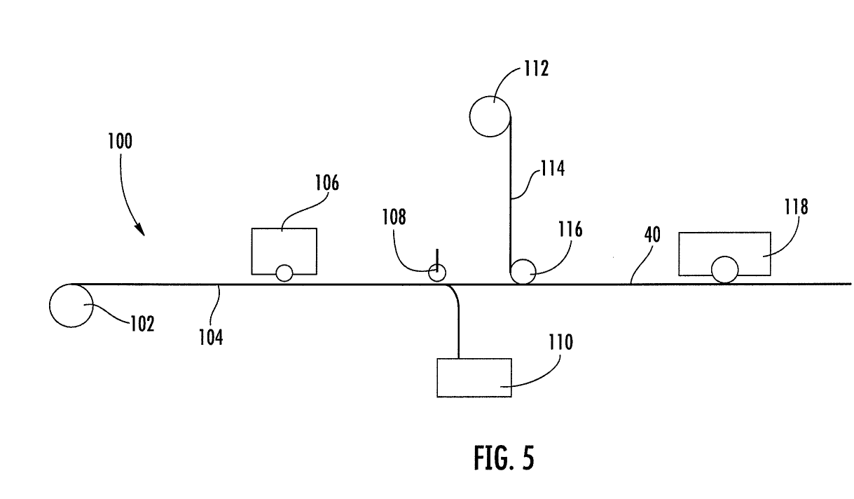

FIG. 5 is a schematic illustration of an exemplary system 100 that can be used for preparing a laminate 40 that is in accordance with the present invention. As shown, a continuous sheet of the paper 104 is supplied from a supply roll 102. Adhesive is then applied to sheet of paper at adhesive station 106 as the paper sheet is moved in the machine direction. The adhesive can be applied using conventional techniques such as with roller, doctor blades, spray coatings, and the like. In one embodiment, the adhesive is applied using a gravure printing process. Preferably, the adhesive is a water-based adhesive. Examples of water-based adhesives that may be used in accordance with the invention include urethane-base adhesives, acrylic-based adhesives, and the like.

In a next step, the sheet of paper is slit into two or more separate strips of paper material at slitting station 108. The two or more strips of paper are used to form the opaque portions of the front and back panels. Waste paper is diverted and removed at station 110. A continuous sheet of film 114 is supplied from a supply roll 102, and is superimposed over the strips of paper. A nip 116 presses the paper strips and film together to thereby form laminate 40. Optionally, the system can include antifog station 118 at which an antifog agent can be applied to the surface of the laminate. The final laminate product is wound on an output reel 120 for subsequent use and conversion.

Preferably, the resulting laminate includes two spaced-apart strips of paper that extend continuously in the machine direction of the laminate and two-spaced apart strips of the polymeric sheet material to which the paper layer has not been applied and that also extend continuously in the machine direction of the laminate. In this embodiment, the one of longitudinal side edges of the laminate include the paper layer whereas the other longitudinal side edge is not covered with the paper layer. During bag making, the longitudinal side edges are folded inwardly towards each other so that each strip of laminate is disposed opposite a strip of the polymeric sheet material to which the outer layer of paper has not been applied. In this way, a bag can be formed in which the front and back panels are configured and arranged with respect to each other such that the opaque portion (i.e. portion of laminate covered with an outer paper layer) of the back panel is aligned opposite the window portion (i.e. portion of laminate in which the polymeric sheet material is not covered with an outer paper layer) of the front panel, and the window portion of the back panel is aligned opposite the opaque portion of the front panel.

Laminates prepared in accordance with the aforementioned process may be used as stock roll for standard equipment adapted to fabricate bags or other dilatable products, by slitting, sealing, folding and whatever other operations are dictated by the form of the product. In particular, the laminate is particularly useful in vertical form fill and seal (VFFS) and horizontal form fill and seal (HFFS) packaging processes.

In an alternative embodiment, the front and back panels can comprise two separate sheets of laminate that are oriented in a face-to-face relation and are sealed to each other along adjacent edges to define a bag having an interior space. In this embodiment, the front and back panels 12, 14 are of a generally rectangular shape, each having a top edge, a bottom edge, and opposite side edges that extend longitudinally from the top edge to the bottom edge of the bag. The front and back panels are joined to one another along the opposed side edges by side seams. As noted above, such seams are preferably formed with heat seals.

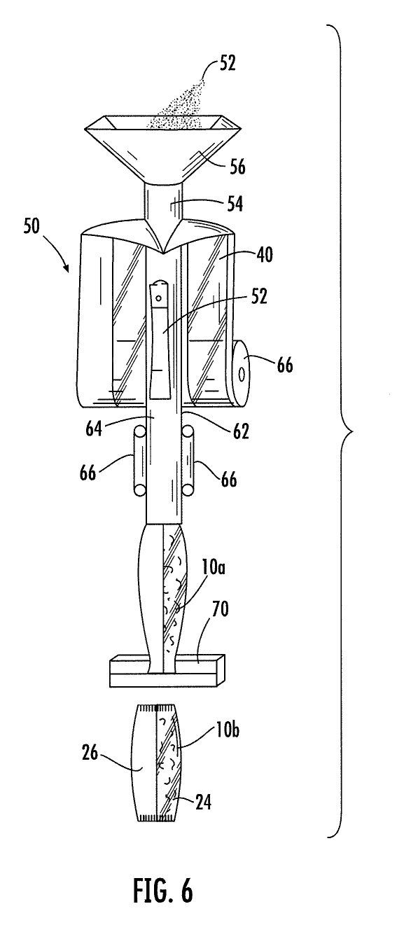

With reference to FIG. 6 a vertical form fill and seal (VFFS) apparatus that may be used in a packaging process according to the present invention is illustrated. Vertical form fill and seal equipment is well known to those of skill in the packaging arts.

In FIG. 6, a vertical form fill and seal apparatus 50 is schematically illustrated. Apparatus 50 utilizes laminate 40 according to the invention. Product 52, to be packaged, is supplied to apparatus 50 from a source (not illustrated), from which a predetermined quantity of product 52 reaches upper end portion of forming tube 54 via funnel 56, or other conventional means. The packages are formed in a lower portion of apparatus 50, and flexible sheet material 10 from which the bags or packages are formed is fed from roll 60 over certain forming bars (not illustrated), is wrapped about forming tube 54, and is provided with longitudinal seal 62 by longitudinal heat sealing device 58, resulting in the formation of vertically-oriented tube 64. End seal bars 70 operate to close and seal horizontally across the lower end of vertically-sealed tube 64, to form bag 10a which is thereafter immediately packed with product 52. Film drive belts 66, powered and directed by rollers, as illustrated, advance tube 64 and bag 10a a predetermined distance, after which end seal bars 70 close and simultaneously seal horizontally across the lower end of vertically-sealed tube 48 as well as simultaneously sealing horizontally across upper end of sealed bag 10b, to form a product packaged in sealed bag 10b. The next bag 10a, thereabove, is then filled with a metered quantity of product 52, forwarded, and so on. It is also conventional to incorporate with the end seal bars a cut-off knife (not shown) which operates to sever a lower sealed bag 10b from the bottom of upstream bag 10a.

FIG. 8 illustrates one embodiment of a packaged product of the present invention, the product being packaged in sealed bag 10b having a window portion 24 an opaque portion 26, vertical seal 46 and top and bottom ends 16, 18 having end seals.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A window bag comprising:
front and back panels arranged in opposing face-to-face relation and being interconnected to define an interior space, the bag having a top end, a bottom end, and a pair of opposing side edges extending longitudinally between the top and bottom ends;
each panel comprising a transparent, heat sealable polymeric sheet material to which an outer layer of paper material is fixedly joined, the paper layer covering the polymeric sheet material except for a window portion that is disposed on one side of each panel, the layer of paper defining an opaque portion of each panel, and wherein the front and back panels are configured and arranged with respect to each other such that the opaque portion of the back panel is aligned opposite the window portion of the front panel, and the window portion of the back panel is aligned opposite the opaque portion of the front panel.

2. The bag of claim 1, wherein the opaque portion of each panel extends laterally from a side edge of the panel to approximately a middle region of the panel.

3. The bag of claim 1, wherein the window portion and opaque portion of each panel extends longitudinally from the top end to the bottom end of the bag.

4. The bag of claim 1, wherein the window portion and opaque portion of each panel extends laterally between the opposing side edges of the bag.

5. The bag of claim 1, wherein the opaque portion of each panel wraps about an adjacent side edge of the bag and is at least partially disposed on the opposite panel.

6. The bag of claim 1, wherein the paper material is kraft paper.

7. The bag of claim 1, wherein the front and back panels are unconnected along the top end to allow for filling of the bag.

8. The bag of claim 1, wherein the front and back panels include inner surfaces that are heat sealed to each other along the bottom end of the bag.

9. The bag of claim 1, wherein the front and back panels comprise a single sheet of the polymeric sheet material having two longitudinal side edges, wherein the sheet material is folded to form said opposing side edges of the bag, and the two longitudinal side edges are sealed to each other to form a vertical seam that extends longitudinally along a length of the bag.

10. The bag of claim 9, wherein the vertical seam comprises a fin seal.

11. The bag of claim 1, wherein the front and back panels comprise separate sheets of material that are joined to each other along their adjacent peripheral edges to form the bag.

12. The bag of claim 1, wherein the opaque portion of the front panel is disposed towards a left side of the front panel, and the window portion of the front panel is disposed towards a right side of the front panel.

13. The bag of claim 1, wherein the window portion of each panel is disposed toward a right side of the panel and is spaced apart from the side edges of the bag.

14. The bag of claim 1, wherein the window portion of each panel covers from about 45 to 55 percent of the panel.

15. The bag of claim 1, wherein the window portion of each panel covers about 50 percent of the panel.

16. The bag of claim 1, wherein in the bag includes micro perforations distributed over the front and back panels.

17. The bag of claim 1, wherein each window portion is substantially rectangular in shape.

18. A window bag comprising:
front and back panels arranged in opposing face-to-face relation and being interconnected to define an interior space, the bag having a top end, a bottom end, and a pair of opposing side edges extending longitudinally between the top and bottom ends;
each panel comprising a transparent, heat sealable polymeric sheet material to which an outer layer of paper material is fixedly joined, the paper layer covering the polymeric sheet material except for a window portion that is disposed on one side of each panel, the layer of paper defining an opaque portion of each panel, and wherein the front and back panels are configured and arranged with respect to each other such that the opaque portion of the back panel is aligned opposite the window portion of the front panel, and the window portion of the back panel is aligned opposite the opaque portion of the front panel, and wherein the window portion and opaque portion of each panel extends longitudinally from the top end to the bottom end of the bag, and the opaque portion of each panel extends laterally from a side edge of the panel to approximately a middle region of the panel.

19. The bag of claim 18, wherein the opaque portion of each panel wraps about an adjacent side edge of the bag and is at least partially disposed on the opposite panel.

20. The bag of claim 18, wherein the paper material is kraft paper.

21. The bag of claim 18, wherein the front and back panels are unconnected along the top end to allow for filling of the bag, and wherein the front and back panels include inner surfaces that are heat sealed to each other along the bottom end of the bag.

22. The bag of claim 21, wherein the front and back panels comprise a single sheet of the polymeric sheet material having two longitudinal side edges, wherein the sheet material is folded to form said opposing side edges of the bag, and the two longitudinal side edges are sealed to each other to form a vertical seam that extends longitudinally along a length of the bag.

23. The bag of claim 22, wherein the vertical seam comprises a fin seal.

24. The bag of claim 1, wherein the window portion of each panel covers from about 45 to 55 percent of the panel.

25. The bag of claim 1, wherein the window portion of each panel covers about 50 percent of the panel.

26. The bag of claim 18, wherein in the bag includes micro perforations distributed over the window portions of the front and back panels.

27. The bag of claim 18, wherein in the bag includes micro-fractures distributed over the front and back panels.

28. A process of preparing a paper-film laminate comprising:
providing a continuous sheet of paper material;
applying an adhesive to a surface of the paper;
splitting the paper into two or more continuous strips that extend in the longitudinal direction of the paper; and
laminating the strips of paper to the polymeric sheet material to form a laminate,
wherein the strips of paper are laterally spaced apart from each other.

29. A paper-film laminate comprising a moisture resistant paper layer that is adhesively laminated to a polymeric layer, the laminate having an oxygen transmission rate that is between about 75 and 240 cc (STP)/m²/day/atm or greater at 23° C. and 0% relative humidity, as measured according to ASTM D-3985, wherein the paper layer has a tensile strength in the machine direction that is about 7.5 lbs./in², a wet tensile strength in the machine direction that is between about 1.5 and 2 lbs./in², and a tear strength in the machine direction that is between about 20 and 25 grams force.
